(19) United States
(12) Patent Application Publication
(10) Pub. No.: US 2007/0104569 A1
(43) Pub. Date: May 10, 2007

(54) Fan with time indication

(76) Inventor: Ming Sea Tsai, Taichung Hsien (TW)

Correspondence Address: Ming Sea Tsai, 235 Chung-Ho, Box 8-24, Taipei, TW

(21) Appl. No.: 11/269,092

(22) Filed: Nov. 9, 2005

(51) Int. Cl. F03B 13/00

(52) U.S. Cl. 415/121.3; 968/398

(57) ABSTRACT

A fan with time indication comprises a fan having a base; a driving unit being installed on the base; a front end of the driving head having a rear net mask and a blade set capable of being driven by the driving unit; a front side of the blade set having a front net mask; the front net mask being combined with the rear net mask so as to enclose the blade set; the front net mask being separable from the rear net mask; the front net mask having a suspending hole by that the fan can be suspending from a wall; and a time indicator installed on the front net mask for displaying time. The time indicator is installed at a center of the front net mask; and the front net mask has a plurality of radiate net-like ribs which are corresponding to the scales of the time scales.

### FIELD OF THE INVENTION

The present invention relates to fans, and in particular to a time indicator is combined to a fan. Thereby the fan has also the function of time indication. Thereby space is saved greatly. Besides, since the fan is faced to the user, the user can view the time directly.

### BACKGROUND OF THE INVENTION

In the prior art, time indicator and fan are separated. However they are arranged at different areas. A great space is necessary. Generally, time indicators, such as alarm clocks, suspending clocks, or table clocks, etc., are arranged at a fixed position, such as beds, tables, or walls. Thus, generally, these clocks are not moved. If is often that the user cannot view the clocks easily and conveniently. Furthermore, when the user leaves the area, he (or she) cannot see the clock immediately.

Thereby there is an eager demand for a novel design which can improve the prior art defect.

### SUMMARY OF THE INVENTION

Accordingly, the primary object of the present invention is to provide a fan with time indication, wherein a time indicator is combined to a fan. Thereby the fan has also the function of time indication. Thereby space is saved greatly. Besides, since the fan is faced to the user, the user can view the time directly.

To achieve above objects, the present invention provides a fan with time indication which comprises a fan having a base; a driving unit being installed on the base; a front end of the driving head having a rear net mask and a blade set capable of being driven by the driving unit; a front side of the blade set having a front net mask; the front net mask being combined with the rear net mask so as to enclose the blade set; the front net mask being separable from the rear net mask; the front net mask having a suspending hole by that the fan can be suspending from a wall; and a time indicator installed on the front net mask for displaying time. The time indicator is installed at a center of the front net mask; and the front net mask has a plurality of radiate net-like ribs which are corresponding to the scales of the time scales.

The various objects and advantages of the present invention will be more readily understood from the following detailed description when read in conjunction with the appended drawing.

### BRIEF DESCRIPTION OF THE DRAWINGS

FIG. 1 is an assembled perspective view of the first preferred embodiment of the present invention.

FIG. 2 is a lateral view of the first preferred embodiment of the present invention.

FIG. 3 is an exploded perspective view of the first preferred embodiment of the present invention.

FIG. 4 is a perspective view of the backside of the first preferred embodiment of the present invention.

FIG. 5 is a front view of the first preferred embodiment of the present invention.

FIG. 6 is a schematic view of the first preferred embodiment of the present invention, wherein the front net mask is separated.

FIG. 7 is a schematic perspective view of the first preferred embodiment of the present invention, wherein the time indicator is separated.

FIG. 8 is a lateral view of the first preferred embodiment of the present invention, wherein the time indicator is separated.

FIG. 9 is a front view of the second preferred embodiment of the present invention.

FIG. 10 is a system block diagram of the present invention.

FIG. 11 is a plane view about the fourth preferred embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

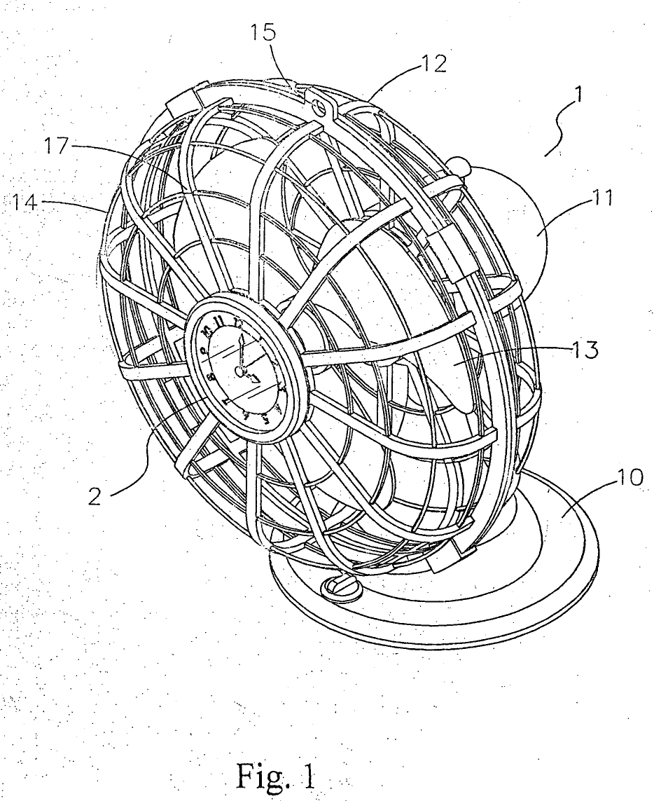

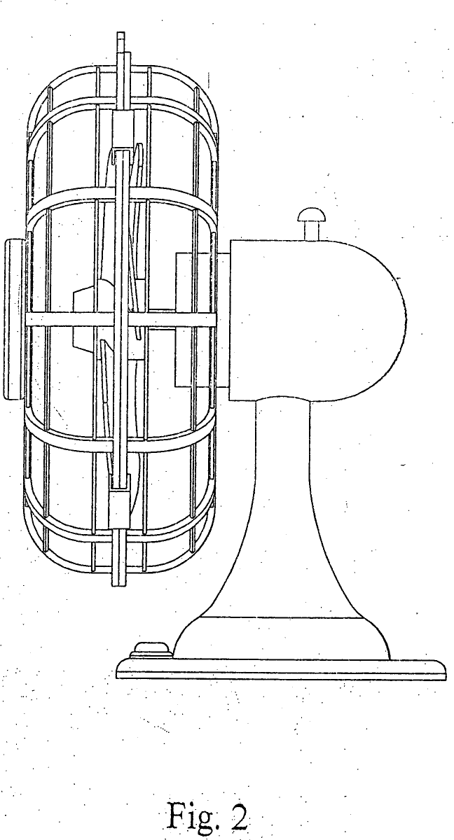

Referring to FIGS. 1 to 8, especially FIGS. 1 and 2, the fan with time indication of the present invention is illustrated. The present invention has the following elements.

A fan 1 has a base 10. A driving unit 11 is installed on the base 10. The driving unit 11 can swing at two sides. A front end of the driving head 11 has a rear net mask 12 and a blade set 13 capable of being driven by the driving unit 11. A front side of the blade set 13 has a front net mask 14. The front net mask 14 is combined with the rear net mask 12 so as to enclose the blade set 13. The front net mask 14 is separable from the rear net mask 12. The front net mask 14 has a suspending hole 15 by that the fan can be suspended from a wall.

A time indicator 2 is installed on the front net mask 14 for displaying time.

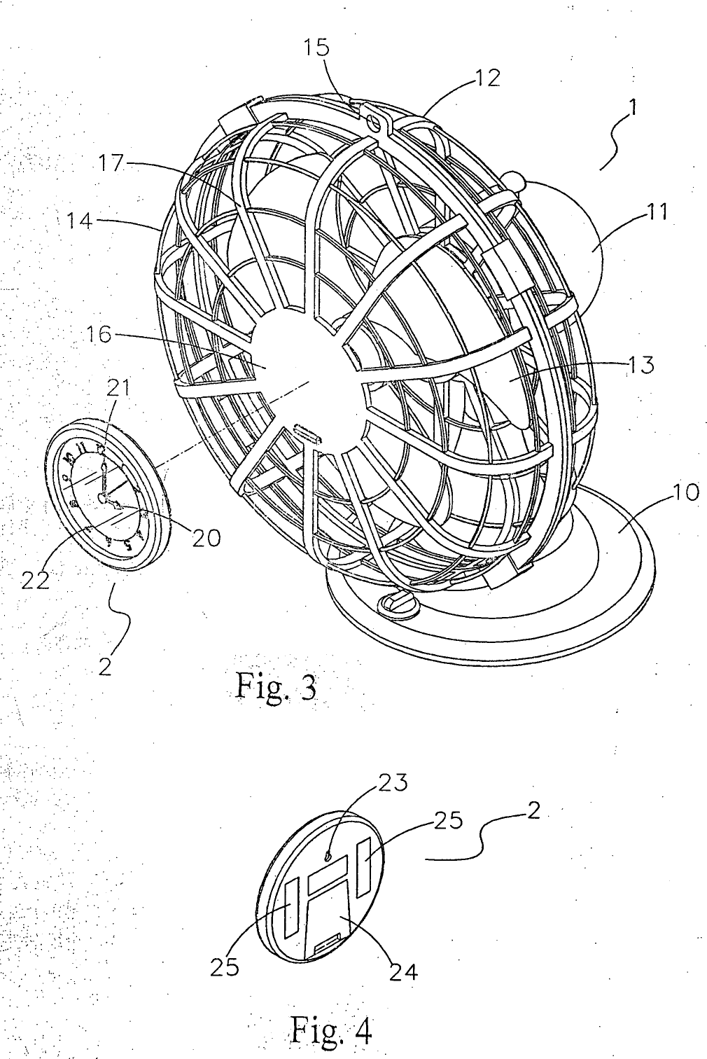

Referring to FIGS. 3 and 4, an iron retainer portion 16 at a central portion of the front net mask 14. A front surface of the time indicator 2 has an hour hand 20, a minute hand 21 and a time scale 22 for indicating time. A backside of the time indicator 2 has a suspending hole 23, a support seat 24, and a plurality of magnets 25. The suspending hole 23 of the time indicator 2 can receive a nail at a wall. The support seat 24 is foldable and expandable. The plurality of magnets 25 can adhere to the retaining portion 16 so as to combine the time indicator 2 to the front net mask 14. In other embodiments, the time indicator 2 can be embedded into, screwed to or buckled to the front net mask 14, or by other ways.

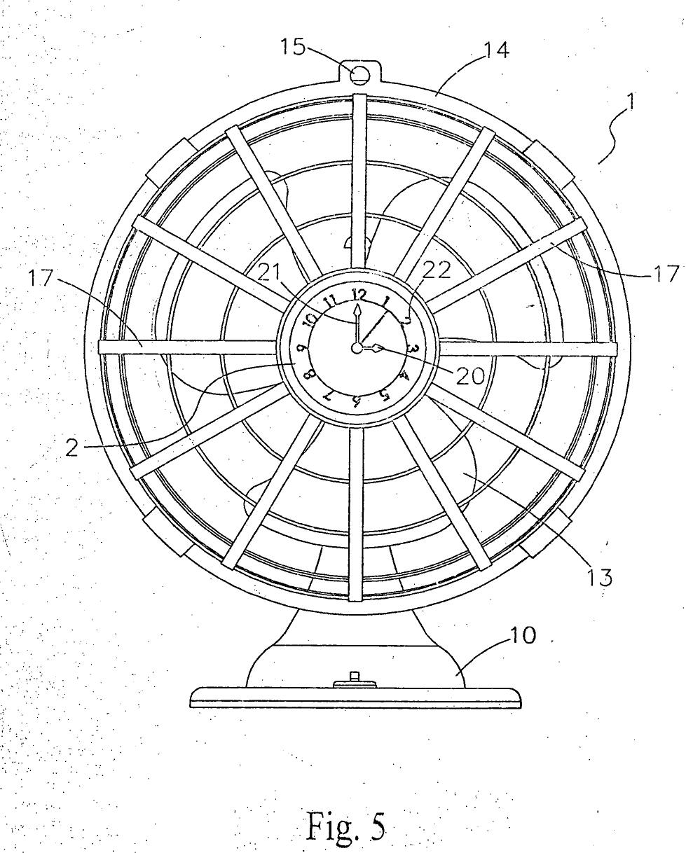

Referring to FIG. 5, the front net mask 14 has a plurality of radiate net-like ribs 17 which are corresponding to the scales of the time scales 22 for viewing by users.

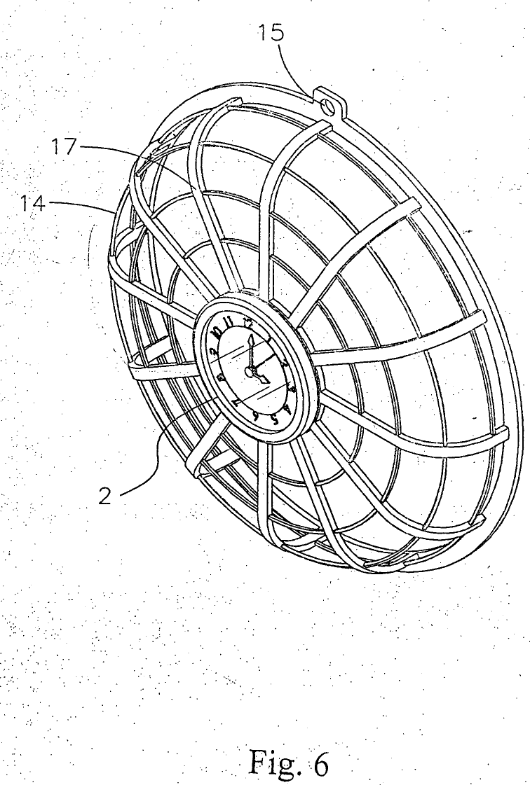

Referring to FIG. 6, when the front net mask 14 is detached from the fan 1, it can be suspended from a wall by the suspending hole thereof. Thereby the front net mask 14 and the time indicator 2 are formed as a suspending clock.

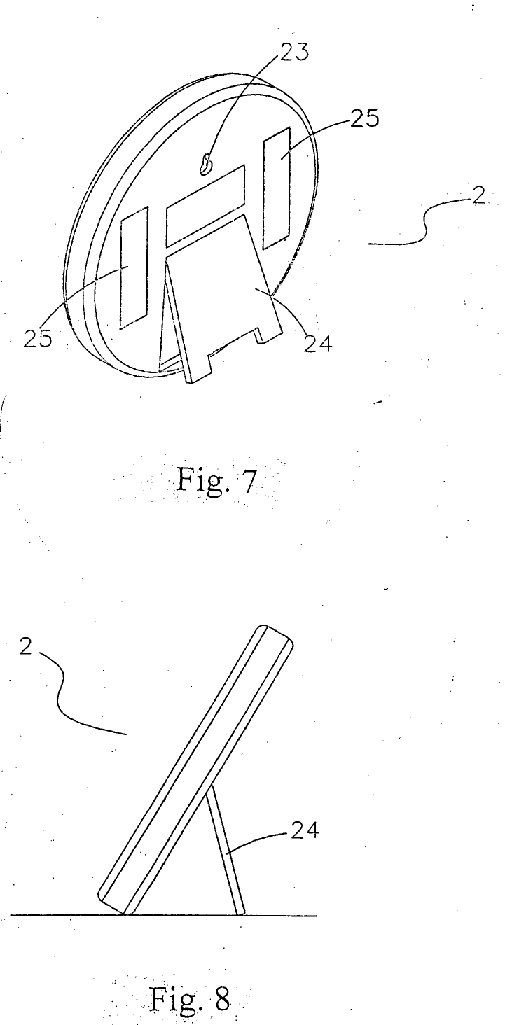

Referring to FIGS. 7 and 8, the time indicator 2 can be separated from the front net mask 14, the support seat 24 at the backside of the time indicator 2 can be expanded for suspending the time indicator 2 so as to be as a table clock or an alarm clock.

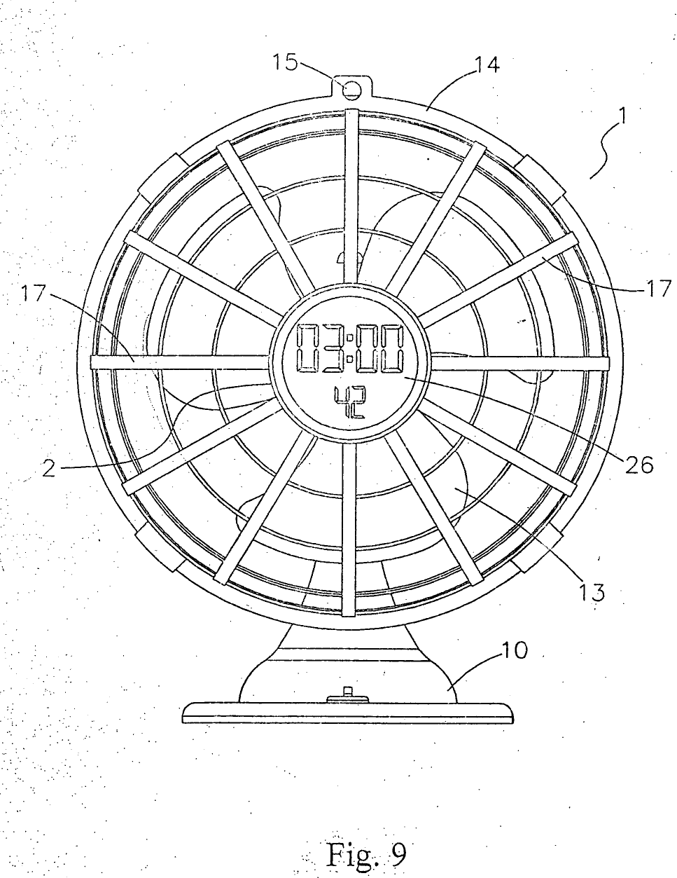

With reference to FIG. 9, the second preferred embodiment of the present invention is illustrated. The difference of this embodiment from the first embodiment is that a front surface of the time indicator 2 has a liquid crystal display screen 26 for displaying time.

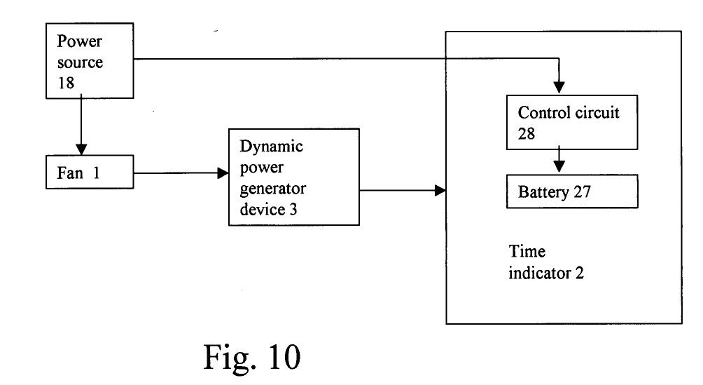

Referring to FIG. 10, the third preferred embodiment of the present invention is illustrated. The difference of the third embodiment from the first embodiment is that the time indicator 2 has a battery set 27 and a control circuit 28. The battery set 27 serves to supply power to the time indicator 2. The control circuit 28 serves to control and drive the operation of the time indicator 2 and is connected to the power source 18 of the fan 1. The power of the power supply is stored in the battery set 27. A power generator 3 is installed between the fan 1 and the time indicator 2 for converting the dynamic power from the operation of fan 1 to the electric power which is stored in the battery set 27 by the control of the control circuit 28.

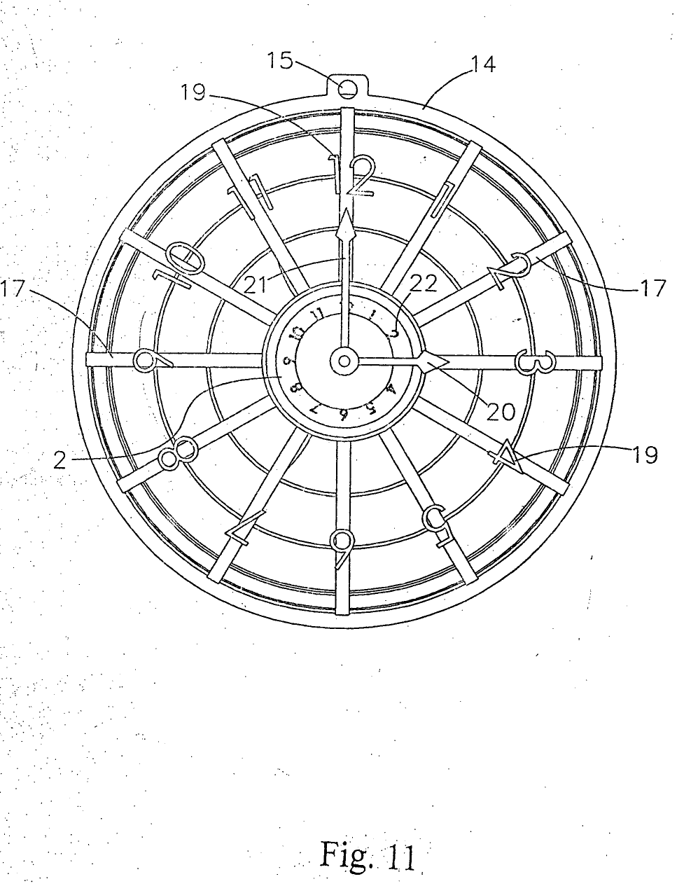

With reference to FIG. 11, the fourth preferred embodiment of the present invention is illustrated. The fourth embodiment is identical to the first embodiment except that the net ribs 17 on the front net mask 14 has numbers 19 corresponding to the time scales 22. The hour hand 20 and minute hand 21 extend out of the time indicator 2 so that the user can clearly view the indication of time.

In the present invention, the time indicator 2 is combined to a fan 1. Thereby the fan 1 has also the function of time indication. Thereby space is saved greatly. Besides, since the fan is faced to the user, the user can view the time directly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fan with time indication comprising;
a fan having a base; a driving unit being installed on the base; a front end of the driving head having a rear net mask and a blade set capable of being driven by the driving unit; a front side of the blade set having a front net mask; the front net mask being combined with the rear net mask so as to enclose the blade set; the front net mask being separable from the rear net mask; the front net mask having a suspending hole by that the fan can be suspended from a wall; and
a time indicator installed on the front net mask for displaying time.

2. The fan with time indication as claimed in claim 1, wherein the time indicator has a liquid crystal display screen for displaying time.

3. The fan with time indication as claimed in claim 1, wherein the time indicator has an hour hand, a minute hand and time scales for displaying time.

4. The fan with time indication as claimed in claim 4, wherein the time indicator is installed at a center of the front net mask; and the front net mask has a plurality of radiate net-like ribs which are corresponding to the scales of the time scales.

5. The fan with time indication as claimed in claim 4, wherein each rib has a number corresponding to the time scale.

6. The fan with time indication as claimed in claim 4, wherein the hour hand and minute hand extend out of the time indicator.

7. The fan with time indication as claimed in claim 1, wherein the time indicator is detachably installed to the front net mask.

8. The fan with time indication as claimed in claim 1, wherein a backside of the time indicator has a suspending hole.

9. The fan with time indication as claimed in claim 1, wherein a backside of the time indicator has a support seat which is foldable and expandable.

10. The fan with time indication as claimed in claim 1, wherein the driving unit is swingable on the base.

11. The fan with time indication as claimed in claim 1, wherein the time indicator has a battery set and a control circuit; the battery set serves to supply power to the time indicator; the control circuit serves to control and drive the operation of the time indicator and is connected to the power source of the fan; and the power of the power supply is stored in the battery set.

12. The fan with time indication as claimed in claim 11, further comprising a power generator installed between the fan and the time indicator for converting the dynamic power from the operation of fan to the electric power which is stored in the battery set.
